(19) United States
(12) Patent Application Publication
(10) Pub. No.: US 2025/0172452 A1
(43) Pub. Date: May 29, 2025

(54) LIQUID LEAK DETECTION APPARATUS

(71) Applicant: SAMSUNG ELECTRONICS CO., LTD., Suwon-si (KR)

(72) Inventors: Jae-Min HA, Suwon-si (KR); Younghoon Shin, Suwon-si (KR); Kwang Soo Kim, Suwon-si (KR); Wookrae Kim, Suwon-si (KR); Donhwan Lee, Suwon-si (KR); Jae Young Lee, Suwon-si (KR); Ho-Hyun Lee, Suwon-si (KR); Cheolmin Jeon, Suwon-si (KR); Chungjeong Hwang, Suwon-si (KR)

(73) Assignee: SAMSUNG ELECTRONICS CO., LTD., Suwon-si (KR)

(21) Appl. No.: 18/663,895

(22) Filed: May 14, 2024

(30) Foreign Application Priority Data
Nov. 23, 2023 (KR) 10-2023-0164434

(51) Int. Cl. G01M 3/28

(52) U.S. Cl. CPC G01M 3/2807

(57) ABSTRACT

A liquid leak detection apparatus includes: a frame having a container structure and including a liquid collection surface at an upper part of the frame; and a liquid leak sensor on the liquid collection surface, wherein the liquid collection surface comprises a liquid collection portion that is disposed on one side of the liquid collection surface, wherein the liquid collection portion is lower in height by a predetermined value than a region where a height of an up-down direction is the greatest in the liquid collection surface, and wherein the liquid leak sensor is on the liquid collection portion.

### CROSS-REFERENCE TO RELATED APPLICATION

This application claims priority to and the benefit of Korean Patent Application No. 10-2023-0164434, filed on Nov. 23, 2023, in the Korean Intellectual Property Office, the entire contents of which are incorporated herein by reference.

### BACKGROUND

### 1. Field

The disclosure relates to a liquid leak detection apparatus.

### 2. Description of Related Art

A semiconductor production facility includes components for a cooling operation. Specifically, the semiconductor production facilities include devices that perform a development process, a deposition process, an etching process, a cleaning process, and/or a drying process, etc. on a substrate. Such devices require the cooling operation to maintain a stable operation due to heat generated during the above processes. Accordingly, the semiconductor production facilities include a piping structure for a flow of a refrigerant and devices connected to the piping structure to circulate the refrigerant.

Additionally, the semiconductor production facilities include high voltage wires to supply an electric power to those devices. Accordingly, if a refrigerant leak occurs, a major accident may occur if the refrigerant leak is not detected early and an action for suppressing the refrigerant leak is not taken.

### SUMMARY

Provided is a liquid leak detection apparatus that may effectively a detect liquid leakage when a liquid leak occurs in a semiconductor production facility.

According to an aspect of the disclosure, a liquid leak detection apparatus includes: a frame having a container structure and including a liquid collection surface at an upper part of the frame; and a liquid leak sensor on the liquid collection surface, wherein the liquid collection surface comprises a liquid collection portion that is disposed on one side of the liquid collection surface, wherein the liquid collection portion is lower in height by a predetermined value than a region where a height of an up-down direction is the greatest in the liquid collection surface, and wherein the liquid leak sensor is on the liquid collection portion.

According to an aspect of the disclosure, a liquid leak detection apparatus includes: a frame having a container structure and including a liquid collection surface positioned at an upper part of the frame; and a liquid leak sensor on the liquid collection surface, wherein the liquid collection surface comprises a liquid collection portion on one side of the liquid collection surface, wherein the liquid collection portion is lower in height by a predetermined value than a region where a height of an up-down direction is the greatest in the liquid collection surface, wherein the liquid collection portion has an area corresponding to a size of the liquid leak sensor, wherein the liquid collection surface comprises a slope portion that slopes downward in a direction from a region farthest from the liquid collection portion toward to the liquid collection portion, and wherein the liquid leak sensor is on the liquid collection portion.

According to an aspect of the disclosure, a liquid leak detection apparatus includes: a frame having a container structure and including a liquid collection surface at an upper part of the frame; and a liquid leak sensor on the liquid collection surface, wherein the liquid collection surface comprises a liquid collection portion on one side of the liquid collection surface, wherein the liquid collection portion is lower in height by a predetermined value than a region where a height of an up-down direction is the greatest in the liquid collection surface, wherein the liquid collection portion has an area corresponding to a size of the liquid leak sensor, wherein the liquid collection surface comprises a slope portion that slopes downward in a direction from a region farthest from the liquid collection portion to the liquid collection portion, wherein the liquid collection surface comprises a plurality of guide panels protruded upward on the slope portion and arranged radially on a circumference of the liquid collection portion, and wherein the liquid leak sensor is disposed on the liquid collection portion.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a view showing a liquid leak detection apparatus according to an embodiment;

FIG. 2 is a top plan view of a liquid leak detection apparatus according to an embodiment;

FIG. 3 is a longitudinal cross-sectional view taken along a line A-A′ of FIG. 2;

FIG. 4 is a view showing a control relationship of a liquid leak detection apparatus according to an embodiment;

FIG. 5 is an enlarged view of a partial region of a slope portion of one (1);

FIG. 6 is an enlarged view of a partial region of a slope portion according to another embodiment;

FIG. 7 is a view showing a contact angle when a liquid is positioned on a slope portion in FIG. 6;

FIG. 8 is a top plan view of a frame according to a second embodiment;

FIG. 9 is a longitudinal cross-sectional view taken along a line B-B′ of FIG. 8;

FIG. 10 is a top plan view of a frame according to a third embodiment;

FIG. 11 is a longitudinal cross-sectional view taken along a line C-C′ of FIG. 10;

FIG. 12 is a top plan view of a frame according to a third embodiment;

FIG. 13 is a longitudinal cross-sectional view taken along a line D-D′ of FIG. 12;

FIG. 14 is a longitudinal cross-sectional view of a liquid leak detection apparatus according to another embodiment; and

FIG. 15 to FIG. 18 are views showing a use state of a liquid leak detection apparatus described above.

### DETAILED DESCRIPTION

The disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the disclosure.

A portion irrelevant to the description will be omitted to clearly describe the disclosure, and the same or similar elements will be designated by the same reference numerals throughout the specification.

The size and thickness of each component illustrated in the drawings are arbitrarily shown for understanding and ease of description, but the disclosure is not limited thereto. Thicknesses of several portions and regions are enlarged for clear expressions. In the drawings, the thickness of layers, films, panels, regions, etc., are exaggerated for clarity. In the drawings, for better understanding and ease of description, the thicknesses of some layers and areas are exaggerated.

The embodiments described herein are non-limiting example embodiments, and thus, the disclosure is not limited thereto and may be realized in various other forms.

Although the terms “first”, “second”, etc. may be used herein to describe various elements or components, these elements or components should not be limited by these terms. These terms are only used to distinguish one element or component from another element or component. Therefore, a first element or component discussed below could be termed a second element or component without departing from the technical spirits of the present disclosure.

When an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. Similarly, the term “set” means one or more. Accordingly, the set of items may be a single item or a collection of two or more items.

Further, in the specification, the phrase “on a plane” means when an object portion is viewed from above, and the phrase “on a cross-section” means when a cross-section taken by vertically cutting an object portion is viewed from the side.

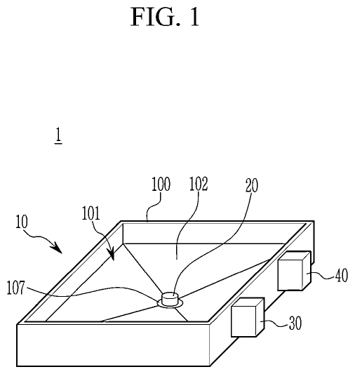

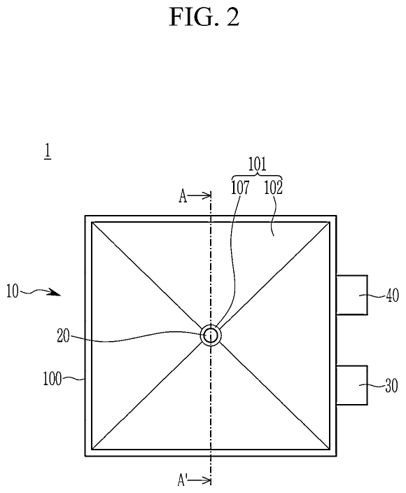

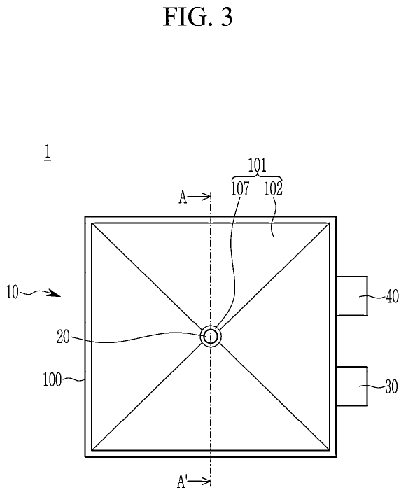

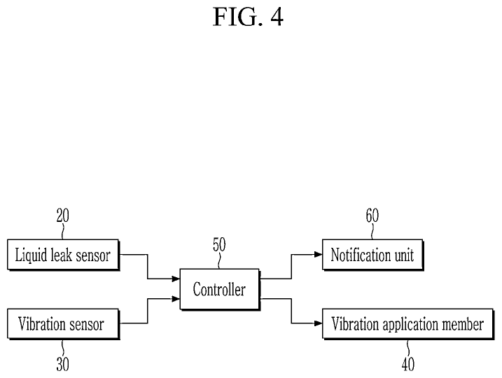

FIG. 1 is a view showing a liquid leak detection apparatus according to an embodiment. FIG. 2 is a top plan view of a liquid leak detection apparatus according to an embodiment. FIG. 3 is a longitudinal cross-sectional view taken along a line A-A′ of FIG. 2. FIG. 4 is a view showing a control relationship of a liquid leak detection apparatus according to an embodiment.

Referring to FIG. 1 to FIG. 4, a liquid leak detection apparatus 1 according to an embodiment includes a frame 10, a liquid leak sensor 20, a vibration sensor 30, a vibration application member 40, and a controller 50.

In an embodiment, the liquid leak detection apparatus 1 is positioned adjacent to other devices that are subject to a monitoring and detects a liquid leak occurring in other devices.

The frame 10 has a container structure of which an upper portion is opened upward. At the upper portion of frame 10, a liquid collection surface 101 is positioned. The liquid collection surface 101 is opened upward. Accordingly, a liquid that falls from the upper side of the frame 10 may fall onto the liquid collection surface 101. The barrier 100 may be disposed on the outer circumference of the liquid collection surface 101. The barrier 100 may protrude upward from the adjacent liquid collection surface 101. The barrier 100 may be disposed to completely surround the outside of the liquid collection surface 101. Accordingly, the liquid contained in the liquid collection surface 101 may be blocked from leaking out of the liquid collection surface 101 by the barrier 100.

The liquid collection surface 101 includes a slope portion 102 and a liquid collection portion 107.

The slope portion 102 is inclined with respect to the horizontal plane. The slope portion 102 may be sloped so that the region farther from the outer edge of the liquid collection surface 101 has a lower height in the up-down direction than the region adjacent to the outer edge of the liquid collection surface 101. As an example, the slope portion 102 may slope downward from the outer edge of the liquid collection surface 101 in a direction away from the outer edge of the liquid collection surface 101. As an example, the slope of the slope portion 102 may be greater than zero degree (0°) to less than or equal to ten degrees (10°).

The liquid collection portion 107 is positioned on one side of the liquid collection surface 101. The liquid collection portion 107 has a height lower, by a predetermined value, than the region with the greatest height in the up-down direction in the liquid collection surface 101. The liquid collection portion 107 may have the lowest height in the up-down direction in the liquid collection surface 101. The area of liquid collection portion 107 may correspond to the size of the liquid leak sensor 20. In some embodiments, when looking from an upper side to a lower side, the shape of the outer circumference of the liquid collection portion 107 may be circular, oval, polygon, etc. The liquid collection portion 107 may be positioned adjacent to the end of the region with the lowest height in the up-down direction in the slope portion 102. That is, the liquid collection portion 107 may be positioned on one side of liquid collection surface 101, in at least some regions of the circumference of liquid collection portion 107, the slope portion 102 may be positioned to slope downward in a direction that approaches the liquid collection portion 107 from the region far from the liquid collection portion 107. The slope portion 102 may be positioned to slope downward toward the liquid collection portion 107 from the outer edge of the liquid collection surface 101. Accordingly, the liquid collection portion 107 collects the liquid that falls on the liquid collection surface 101.

At this time, in the slope portion 102, the direction from the outer edge of the liquid collection surface 101 toward the liquid collection portion 107 may be referred to as the ‘length’ direction of the slope portion 102.

The height of the up-down direction of the liquid collection portion 107 may correspond to the end of the adjacent slope portion 102. As an example, the height of the up-down direction of the liquid collection portion 107 may be the same as the end of the adjacent slope portion 102. Additionally, the height of the up-down direction of the liquid collection portion 107 may be lower than the end of the adjacent slope portion 102. Accordingly, a step may be formed between the end of the slope portion 102 where the height of the up-down direction is lowest and the liquid collection portion 107. Additionally, the liquid collection portion 107 is not limited to a horizontal surface shape. As an example, the liquid collection portion 107 may be positioned on the region where the ends with the lowest height of the up-down direction meet each other in the slope portion 102 which are positioned in the different regions. Accordingly, a slope may be formed to correspond to the adjacent slope portion 102 in at least some regions of the liquid collection portion 107.

The liquid leak sensor 20 is (disposed) on the liquid collection surface 101 of the frame 10 and is configured to detect the liquid that has fallen on the liquid collection surface 101 of the frame 10. The liquid leak sensor 20 may be disposed on the liquid collection portion 107. As the area of the liquid collection portion 107 corresponds to the size of the liquid leak sensor 20, when the liquid leak sensor 20 is disposed on the liquid collection portion 107, most of the liquid collection portion 107 may be covered by the liquid leak sensor 20.

The liquid leak sensor 20 may be a contact type and may be configured to detect when it comes into contact with the liquid. The liquid leak sensor 20 may transmit and receive different signals depending on a presence or an absence of the liquid contact.

The vibration sensor 30 is configured to detect a vibration occurring in the frame 10. The vibration sensor 30 is disposed adjacent to one side of the frame 10. As an example, the vibration sensor 30 may be a contact type vibration sensor 30 and may have a state attached to one side of the frame 10. The vibration sensor 30 may be disposed on the exterior side of the frame 10. The vibration sensor 30 may be disposed in a region opposite to the liquid collection surface 101 with the barrier 100 as a reference. Accordingly, the vibration sensor 30 may be prevented from being exposed to the liquid dropped on the liquid collection surface 101 of the frame 10.

In an embodiment, the vibration sensor 30 may be disposed on the interior side of the frame 10. In an embodiment, the vibration sensor 30 may be configured to be water-proof. Accordingly, even if the vibration sensor 30 is exposed to the liquid dropped on the liquid collection surface 101 of the frame 10, operations of the vibration sensor 30 are not interfered by the liquid.

Additionally, the vibration sensor 30 may be or correspond to a non-contact type vibration sensor 30 and may be disposed adjacent to the frame 10 while being spaced from the outer surface of the frame 10. As an example, the vibration sensor 30 may be installed on a structure positioned adjacent to the frame 10.

FIG. 1 and FIG. 2 shows an example in which the vibration sensor 30 has a state attached to the frame 10. The vibration sensor 30 may transmit and receive different signals depending on the presence or absence of the vibration. Additionally, the signal transmitted by the vibration sensor 30 may include a data regarding the magnitude of the vibration. For example, the data transmitted/received by the vibration sensor 30 may include a data about the magnitude of the amplitude generated on the outer surface of the frame 10 due to the vibration.

In an embodiment, the vibration application member 40 may be configured to cause (or generate) the vibration to the frame 10. For example, the vibration application member 40 corresponds to an actuator (such as a linear resonant actuator).

The term “member” used in the disclosure refer to a hardware component such as a processor or a circuit, and/or a software component executed by a hardware component such as a processor. A “member” may be implemented by a program that is stored in a storage medium which may be addressed, and is executed by a processor. For example, a “member” may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters.

As an example, the vibration application member 40 may include a mass body of which a mass distribution is eccentric with respect to the rotation axis. Additionally, the vibration application member 40 may be attached to one side of frame 10. Accordingly, the vibration application member 40 may generate the vibration as the mass body rotates, and the vibration may be transmitted to the frame 10 to which the vibration application member 40 is attached. Additionally, the vibration application member 40 may be disposed adjacent to the frame 10 to be able to hit one side of the frame 10. Accordingly, when the vibration application member 40 hits the frame 10, the vibration may occur in the frame 10.

The controller 50 may control components of the liquid leak detection apparatus 1. The controller 50 may be disposed on one side of the frame 10. Additionally, the controller 50 may be disposed away from the frame 10.

The controller 50 may be operatively or electrically connected to the liquid leak sensor 20. As an example, the controller 50 may be connected to the liquid leak sensor 20 through a wire. Additionally, the controller 50 may be connected to the liquid leak sensor 20 through a wireless communication. The controller 50 may detect whether there is liquid on the liquid collection surface 101 of the frame 10 through a signal received from the liquid leak sensor 20. Accordingly, the controller 50 may monitor whether liquid leakage has occurred in the space positioned above the installed point of the frame 10.

The controller 50 may be operatively or electrically connected to the vibration sensor 30. As an example, the controller 50 may be connected to the vibration sensor 30 through a wire. Additionally, the controller 50 may be connected to the liquid leak sensor 20 through wireless communication. The controller 50 may monitor whether the liquid has fallen on the frame 10 through the signal received from the vibration sensor 30. As an example, the controller 50 may monitor the magnitude of the vibration occurring in the frame 10 through a signal received from the vibration sensor 30. Additionally, if the magnitude of the vibration measured to have occurred in the frame 10 through the signal received from the vibration sensor 30 is greater than or equal to a predetermined value, the controller 50 may determine that the vibration occurred due to the liquid falling on the frame 10.

Additionally, the controller 50 may monitor the waveform of the vibration occurring in the frame 10 through the signal received from the vibration sensor 30. Also, the controller 50 may save a data on the reference waveform that occurs when the liquid falls on the frame 10. Accordingly, if the similarity between the vibration waveform of the frame 10 according to the signal received from the vibration sensor 30 and the reference waveform is greater than or equal to a predetermined value, the controller 50 may determine that the vibration occurred due to the liquid falling on the frame 10. On the other hand, if the magnitude of the vibration of the frame 10 according to the signal received from the vibration sensor 30 is greater than a predetermined value, and the similarity between the vibration waveform of the frame 10 and the reference waveform is greater than a predetermined value, the controller 50 may determine that the vibration occurred due to the liquid falling on the frame 10.

The controller 50 may operate the vibration application member 40 to generate the vibration in the frame 10. The controller 50 may be operatively or electrically connected to the vibration application member 40. As an example, the controller 50 may be connected to the vibration application member 40 through a wire. Additionally, the controller 50 may be connected to the vibration application member 40 through a wireless communication. If it is determined that the vibration has occurred due to the liquid dropping on the frame 10 through the signal received from the vibration sensor 30, the controller 50 may operate the vibration application member 40. Due to the vibration generated by the vibration application member 40, the liquid that falls on the liquid collection surface 101 of the frame 10 may flow down along the slope portion 102 more effectively and be collected in the liquid collection portion 107. In addition, after it is determined that the vibration has occurred due to the liquid falling on the frame 10 through the signal received from the vibration sensor 30, if the liquid is not detected through the signal received from the liquid leak sensor 20 within a predetermined time, the controller 50 may operate the vibration application member 40. On the other hand, after it is determined that the vibration has occurred due to the liquid falling on the frame 10 through the signal received from vibration sensor 30, if the liquid is detected through the signal received from the liquid leak sensor 20 within a predetermined time, the controller 50 may not operate the vibration application member 40.

The controller 50 may be operatively or electrically connected to a notification circuit 60. As an example, the controller 50 may be connected to the notification circuit 60 through a wire. Additionally, the controller 50 may be connected to notification circuit 60 through a wireless communication. If it is determined that the liquid has fallen on the frame 10 through the signal received from the liquid leak sensor 20, the controller 50 may transmit a warning signal to the notification circuit 60 to output the warning signal from the notification circuit 60.

In an embodiment, the controller 50 includes or corresponds to circuitry like a central processing unit (CPU), a microprocessor unit (MPU), an application processor (AP), a coprocessor (CP), a system-on-chip (SoC), or an integrated circuit (IC). The controller 50 may correspond to at least one controller or processor.

As an example, the notification circuit 60 may be a speaker that outputs the warning signal in a form of a sound. Additionally, the notification circuit 60 may be a display panel that outputs the warning signal in a visual form. Additionally, the notification circuit 60 may include a speaker that outputs the warning signal in the sound form and a display panel that outputs the warning signal in the visual form.

The notification circuit 60 may have a state attached to one side of frame 10. That is, the notification circuit 60 may be a speaker, a display panel, etc. attached to one side of the frame 10.

Additionally, the notification circuit 60 may be positioned away from the frame 10. That is, the notification circuit 60 may be a speaker, a display panel, etc. installed on one side of the facility where the liquid leak detection apparatus 1 is installed.

Additionally, the controller 50 may transmit the warning signal to a control device used to use and manage a facility in which the liquid leak detection apparatus 1 is installed. Accordingly, the control device of the facility may output the warning signal through a speaker, a display panel, etc. included therein. Additionally, the control device of the facility may stop the operation of the facility positioned in the area where the frame 10 of the liquid leak detection apparatus 1 is installed according to the warning signal. In this case, the control device of the facility, or a speaker, a display panel, etc. included in the control device of the facility may function as the notification circuit 60.

Additionally, the controller 50 may transmit the warning signal to a device of a worker who uses and manages the facility. The device may be a mobile phone, a tablet PC, a PC, or other portable devices that users use for work within the facility. The device may output the received warning signal in an auditory or visual form. In this case, the device may function as the notification circuit 60.

The liquid leak detection apparatus 1 according to an embodiment may effectively detect even when a relatively small amount of the liquid falls on the frame 10. In other words, if a relatively small amount of the liquid falls compared to the area of the upper portion of the device that detects the drop of the liquid, the liquid may be not in contact with the sensor. At this time, liquid leak detection apparatus 1 according to an embodiment allows the liquid to be detected by moving to the region where the liquid leak sensor 20 is disposed even when a small amount of the liquid falls on the frame 10.

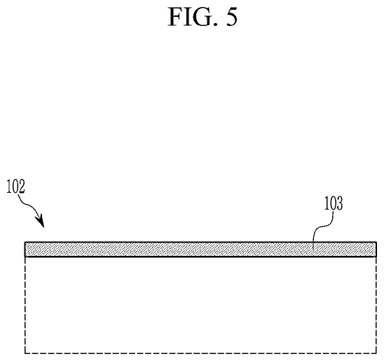

FIG. 5 is an enlarged view of a partial region of a slope portion of 1.

Referring to FIG. 5, a hydrophobic layer 103 may be disposed on a slope portion 102 of a frame 10. The hydrophobic layer 103 is hydrophobic. Accordingly, when a hydrophilic liquid such as water falls on the slope portion 102 of the frame 10, the liquid slides well against the slope portion 102 of the frame 10.

The hydrophobic layer 103 may be formed by coating a hydrophobic coating material. The hydrophobic coating material has low surface energy, which increases a contact angle formed at the boundary between the surface of the object and the hydrophilic liquid, and allows the hydrophilic liquid to effectively slide on the object. The hydrophobic coating material may be a polymer material such as fluorine polymer, silica, metal oxide, carbon nano-material, polypropylene, and polystyrene or the like. A chemical vapor deposition using plasma, a lithography, an anodizing process, a sol gel process, a micro phase separation process, a casting method, a spray coating, an electrochemical deposition, a self-assembly of nanoparticles, etc. may be used to coat the hydrophobic layer 103.

In an embodiment, the hydrophobic layer 103 may be only formed on the slope portion 102. In an embodiment, such hydrophobic layer 103 may be formed on the entire region of the liquid collection surface 101 of frame 10.

Due to the hydrophobic layer 103, when a hydrophilic liquid such as water falls on the slope portion 102 of the frame 10, a large contact angle is formed between the liquid and the slope portion 102 of the frame 10. For example, the contact angle between the liquid and the slope portion 102 of the frame 10 may be 90° or more. Preferably, the hydrophobic layer 103 is super hydrophobic, so that the contact angle between the liquid and the slope portion 102 of the frame 10 is greater than 110°.

Accordingly, the liquid effectively slides on the frame 10. In addition, the liquid collection surface 101 of the frame 10 is a downwardly inclined structure toward the liquid collection portion 107, so that the liquid may effectively slide toward the liquid collection portion 107.

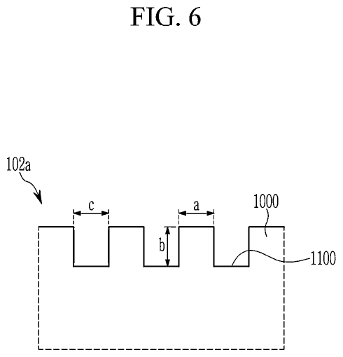

FIG. 6 is an enlarged view of a partial region of a slope portion according to another embodiment.

Referring to FIG. 6, protrusions 1000 and depressions 1100 may be formed on the slope portion 102a. On the surface of the slope portion 102a, the protrusions 1000 are formed to be protruded outward from the adjacent regions, and the regions other than protrusions 1000 may be the depressions 1100. For example, when the protrusions and depressions structure is formed in a relief form through an etching process, the protrusions 1000 are left to have a pattern, and other regions may be etched to become the depressions 1100.

In contrast, on the surface of slope portion 102a, the depressions 1100 that are depressed inward than the adjacent region may be formed, and regions other than the depressions 1100 may be the protrusions 1000. For example, when the protrusions 1000 and the depressions 1100 are in a form of an intaglio through an etching process, the depressions 1100 are etched to have a pattern, and other regions remain to be the protrusions 1000.

Each protrusions 1000 may have a predetermined width ‘a.’ The width ‘a’ of the protrusions 1000 may be 10 nm to 100 μm. The protrusions 1000 may have a predetermined height ‘b.’ The height ‘b’ of the protrusions 1000 may also be a depth ‘b’ of the depressions 1100. The height ‘b’ of the protrusions 1000 may be 10 nm to 100 μm. The adjacent protrusions 1000 may be positioned spaced apart by a predetermined interval ‘c.’ The interval ‘c’ between the adjacent protrusions 1000 may be 10 nm to 100 μm.

The height ‘b’ of the protrusions 1000 may be a distance between the top of the protrusions 1000 and the bottom of the depressions 1100 in the adjacent protrusions 1000 and depressions 1100.

The width ‘a’ of the protrusions 1000 may be measured at a point spaced by a predetermined distance from the bottom of the depressions 1100 in the upward direction. As an example, the width a of the protrusions 1000 may be measured at a point corresponding to 10% to 90% of the height of the protrusions 1000 in the upward direction from the bottom of the depressions 1100. Additionally, the width ‘a’ of the protrusions 1000 may be measured at a point corresponding to 40% to 60% of the height of the protrusions 1000 in the direction from the bottom of the depressions 1100 to the top.

The interval ‘c’ between the adjacent protrusions 1000 may be measured at a point spaced apart from the bottom of the depressions 1100 by a predetermined distance in the upward direction. As an example, the interval ‘c’ between the adjacent protrusions 1000 may be measured at a point corresponding to 10% to 90% of the height of the protrusions 1000 in the direction from the bottom of the depressions 1100 to the top. Additionally, the interval ‘c’ between the adjacent protrusions 1000 may be measured at a point corresponding to 40% to 60% of the height of the protrusions 1000 in the direction from the bottom of the depressions 1100 to the top. The height at which the interval c between the adjacent protrusions 1000 is measured may correspond to the height at which the width a of the protrusions 1000 is measured.

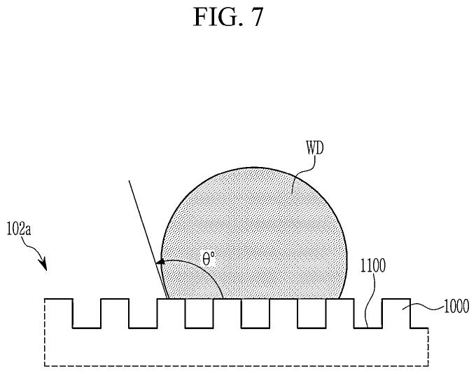

FIG. 7 is a view showing a contact angle θ when a liquid WD is positioned on a slope portion 102a in FIG. 6.

Referring to FIG. 7, the depressions 1100 maintains an air-filled state, so the depressions 1100 is blocked from being in contact with the liquid WD. Accordingly, as the area where the liquid WD is in contact with the slope portion 102a decreases, the contact angle θ between the slope portion 102a and the liquid WD increases. For example, due to the protrusions and depressions structure of the slope portion 102a, the contact angle θ between the slope portion 102a and the liquid WD may be 90° or more. Preferably, the contact angle θ between the liquid WD and the slope portion 102a may be greater than 110°. Accordingly, the liquid WD effectively slides on the frame 10.

In an embodiment, the protrusions and depressions structures may be formed on the slope portion 102a. In an embodiment, the protrusions and depressions structures may be formed on the entire region of the liquid collection surface 101 of the frame 10.

Additionally, the protrusions and depressions structure described in FIG. 6 and FIG. 7 may be used together the hydrophobic layer 103 described above in FIG. 5. In other words, the surface with the protrusions and depressions structure may be provided as a hydrophobic layer 103.

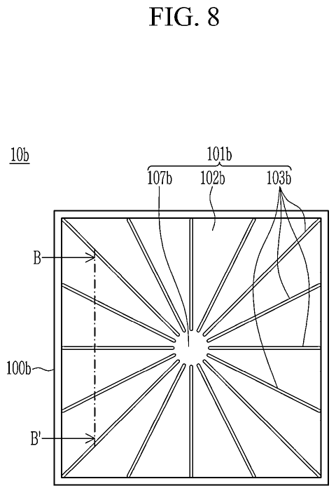

FIG. 8 is a top plan view of a frame 10b according to a second embodiment.

Referring to FIG. 8, the frame 10b has a container structure with the upper portion is opened upward. At the upper portion of the frame 10b, the liquid collection surface 101b is positioned. The liquid collection surface 101b is opened upward. The barrier 100b may be disposed on the outer circumference of the liquid collection surface 101b. The barrier 100b may protrude upward from the adjacent liquid collection surface 101b. The barrier 100b may be disposed to completely surround the outside of the liquid collection surface 101b.

The liquid collection surface 101b includes a slope portion 102b, a guide panel 103b, and a liquid collection portion 107b.

The slope portion 102b is inclined with respect to the horizontal plane. In the slope portion 102b, the height of the up-down direction is lower in the region farther from the outer edge of the liquid collection surface 101b than in the region adjacent to the outer edge of the liquid collection surface 101b. As an example, the slope portion 102b may slope downward from the outer edge of the liquid collection surface 101b toward a direction away from the outer edge of the liquid collection surface 101b.

The guide panel 103b is disposed on the slope portion 102b and the slope portion 102b is portioned into a plurality of regions. The guide panel 103b protrudes upward from the adjacent slope portion 102b.

The liquid collection portion 107b is positioned on one side of the liquid collection surface 101b. The liquid collection portion 107b has a height lower than the region where the height of the up-down direction is the greatest, by a predetermined value, in the liquid collection surface 101b. The liquid collection portion 107b may be provided with the lowest height of the up-down direction in the liquid collection surface 101b. The area of the liquid collection portion 107b may correspond to the size of the liquid leak sensor 20. When looking from a top to a bottom, the shape of the outer circumference of liquid collection portion 107b may be circular, oval, polygon, etc. The liquid collection portion 107b may be positioned adjacent to the end of the region where the height of the up-down direction is lowest in the slope portion 102b. That is, the liquid collection portion 107b may be positioned on one side of the liquid collection surface 101b, in at least some regions of the circumference of the liquid collection portion 107b, the slope portion 102b may be positioned to slope downward in a direction from the region far from the liquid collection portion 107b to the direction approaching the liquid collection portion 107b. The slope portion 102b may be formed to slope downward from the outer edge of the liquid collection surface 101b toward the liquid collection portion 107b. At this time, in the slope portion 102b, the direction from the outer edge of the liquid collection surface 101b toward the liquid collection portion 107b may be referred to as the ‘length’ direction of the slope portion 102b.

The ‘length’ direction of the guide panel 103b may be directed to the ‘length’ direction of the slope portion 102b. One end of the guide panel 103b may be disposed adjacent to the outer edge of the liquid collection surface 101b. One end of the guide panel 103b may be connected to the barrier 100b. The other end of the guide panel 103b may be disposed adjacent to the liquid collection portion 107b. That is, when a plurality of guide panels 103b are provided, the plurality of guide panels 103b may be arranged in a form that converges toward the liquid collection portion 107b. For example, when the liquid collection portion 107b is positioned in the central region of the liquid collection surface 101b, the plurality of guide panels 103b may be arranged radially on the circumference of the liquid collection portion 107b.

The height of the up-down direction of the liquid collection portion 107b may correspond to the end of the adjacent slope portion 102b. As an example, the height of the up-down direction of the liquid collection portion 107b may be the same as the end of the adjacent slope portion 102b. Additionally, the height of the up-down direction of the liquid collection portion 107b may be lower than the end of the adjacent slope portion 102b. Accordingly, a step may be formed between the end of the slope portion 102b where the height of the up-down direction is lowest and the liquid collection portion 107b. Additionally, the liquid collection portion 107b is not limited to the horizontal surfaces. As an example, the liquid collection portion 107b may be positioned on a region where the ends with the lowest height of the up-down direction meet each other in the slope portion 102b positioned in different regions. Accordingly, a slope may be formed to correspond to the adjacent slope portion 102b in at least some regions of the liquid collection portion 107b.

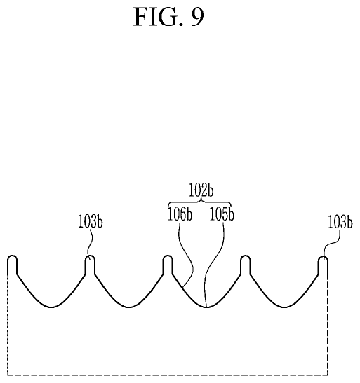

FIG. 9 is a longitudinal cross-sectional view taken along a line B-B′ of FIG. 8.

Referring to FIG. 9, the slope portion 102b has different heights for each region along the direction intersecting the length direction of the slope portion 102b. The slope portion 102b may include a recessed portion 105b and a sliding portion 106b.

The recess portion 105b has the lower height of the up-down direction than the region adjacent in the direction intersecting the length direction of the slope portion 102b. The recess portion 105b may be positioned between the adjacent guide panels 103b. The recess portion 105b may have both ends inclined upward in the direction that intersects the length direction of the slope portion 102b. The recess portion 105b may be inclined downward along the length direction of the slope portion 102b so that the side facing the liquid collection portion 107 faces downward.

The sliding portion 106b may be respectively positioned on both sides of the recess portion 105b in a direction that intersects the length direction of the slope portion 102b. In the direction intersecting the length direction of the slope portion 102b, the sliding portion 106b may connect the upper end of the recess portion 105b and the lower end of the guide panel 103b. The upper end of the guide panel 103b is protruded to a predetermined length higher than the upper end of the sliding portion 106b. The height of the upper end of the sliding portion 106b may correspond to each other. Additionally, the upper end of the sliding portion 106b may be inclined downward along the length direction of the slope portion 102b so that the side facing the liquid collection portion 107 faces downward.

The liquid, which falls on the liquid collection surface 101b, may slide on the guide panel 103b and the sliding portion 106b, and thus, the liquid may be collected in the recess portion 105b. Also, the recess portion 105b converges in the liquid collection portion 107b in the form of a narrow trench, so that the liquid collected in the recess portion 105b may be effectively moved to the liquid collection portion 107b. Additionally, when the liquid meets the liquid collection surface 101b after falling, the liquid slides on the guide panel 103b or the sliding portion 106b. Accordingly, splashing or spreading of the liquid due to the force acting on the liquid when the liquid meets the liquid collection surface 101b may be prevented.

On the liquid collection surface 101b of the frame 10b, the hydrophobic layer 103 described above in FIG. 5 may be formed, and repeated descriptions thereof will be omitted.

Additionally, the protrusions and depressions structure (the protrusions 1000 and the depressions 1100) described above in FIG. 6 and FIG. 7 may be formed on the liquid collection surface 101b of the frame 10b, and repeated explanations thereof will be omitted.

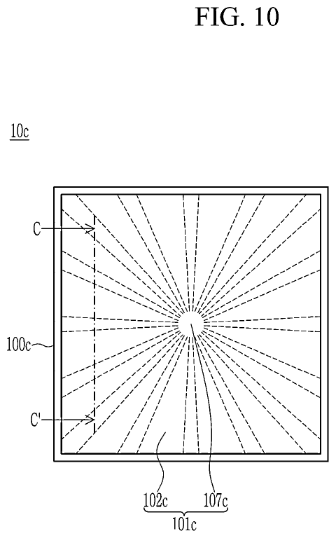

FIG. 10 is a top plan view of a frame 10c according to a third embodiment.

Referring to FIG. 10, the frame 10c has a container structure of which the upper portion is opened upward. The liquid collection surface 101c is positioned at the upper portion of the frame 10c. The liquid collection surface 101c is provided to be opened upward. The barrier 100c may be disposed on the outer circumference of the liquid collection surface 101c. The barrier 100c may protrude upward from the adjacent liquid collection surface 101c. The barrier 100c may be disposed to completely surround the outside of the liquid collection surface 101c.

The liquid collection surface 101c includes a slope portion 102c and a liquid collection portion 107c.

The slope portion 102c is inclined with respect to the horizontal plane. In the slope portion 102c, the height of the up-down direction is lower in the region farther from the outer edge of the liquid collection surface 101c than in the region adjacent to the outer edge of the liquid collection surface 101c. As an example, the slope portion 102c may slope downward from the outer edge of the liquid collection surface 101c in a direction away from the outer edge of the liquid collection surface 101c.

The liquid collection portion 107c is positioned on one side of the liquid collection surface 101c. The liquid collection portion 107b has a height lower than the region where the height of the up-down direction is the greatest, by a predetermined value, in the liquid collection surface 101c. The liquid collection portion 107c may have the lowest height of the up-down direction in the liquid collection surface 101c. The area of liquid collection portion 107c may correspond to the size of the liquid leak sensor 20. When looking from a top to a bottom, the shape of the outer circumference of the liquid collection portion 107c may be circular, oval, polygon, etc. The liquid collection portion 107c may be positioned adjacent to the end of the region where the height of the up-down direction is lowest in the slope portion 102c. That is, the liquid collection portion 107c may be positioned on one side of the liquid collection surface 10c, in at least some regions of the circumference of the liquid collection portion 107c, the slope portion 102c may slope downward in a direction from the region far from the liquid collection portion 107c to the direction approaching the liquid collection portion 107c. The slope portion 102c may slope downward from the outer edge of the liquid collection surface 101c toward the liquid collection portion 107c. At this time, in the slope portion 102c, the direction from the outer edge of the liquid collection surface 101c toward the liquid collection portion 107c may be referred to as the ‘length’ direction of the slope portion 102c.

The height of the up-down direction of the liquid collection portion 107c may correspond to the end of the adjacent slope portion 102c. For example, the height of the up-down direction of the liquid collection portion 107c may be the same as the end of the adjacent slope portion 102c. Additionally, the height of the up-down direction of the liquid collection portion 107c may be lower than the end of the adjacent slope portion 102c. Accordingly, a step may be formed between the end of the slope portion 102c where the height of the up-down direction is lowest and the liquid collection portion 107c. Additionally, the liquid collection portion 107c is not limited to a horizontal surface. As an example, the liquid collection portion 107c may be positioned on a region where the ends with the lowest heights of the up-down direction meet each other in the slope portions 102c, which is positioned in different regions. Accordingly, a slope may be formed in at least some regions of the liquid collection portion 107c to correspond to the adjacent slope portion 102c.

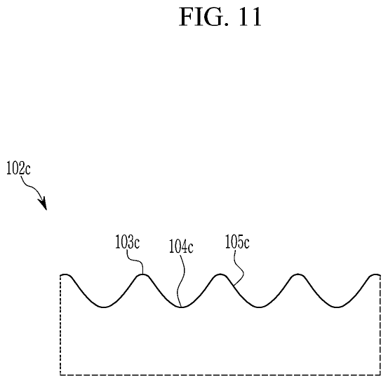

FIG. 11 is a longitudinal cross-sectional view taken along a line C-C′ of FIG. 10.

Referring to FIG. 11, the slope portion 102c has different heights for each region along the direction that intersects the length direction of the slope portion 102c. The slope portion 102c may include a convex portion 103c, a recess portion 104c, and a sliding portion 105c.

The convex portion 103c has the higher height of the up-down direction than the height of the adjacent region in a direction that intersects the length direction of the slope portion 102c. The convex portion 103c may be inclined downward along the length direction of the slope portion 102c so that the side facing the liquid collection portion 107c faces downward. Additionally, the convex portion 103c may have a corresponding height along the length direction of the slope portion 102c.

The recess portion 104c has the height of the up-down direction lower than the region adjacent in a direction that intersects the length direction of the slope portion 102c. The recess portion 104c may be positioned between adjacent convex portions 103c. The recess portion 104c may have both ends inclined upward in a direction that intersects the length direction of the slope portion 102c. The recess portion 104c may be inclined downward along the length direction of the slope portion 102c so that the side facing the liquid collection portion 107c faces downward.

The sliding portion 106c may be respectively positioned on both sides of the recess portion 105c in a direction that intersects the length direction of the slope portion 102c. The sliding portion 105c may be positioned between the convex portion 103c and the recess portion 104c in a direction that intersects the length direction of the slope portion 102c.

The liquid, which falls on the liquid collection surface 101c, may slide through the convex portion 103c and the sliding portion 105c and be collected in the recess portion 104c. Also, the recess portion 104c converges to the liquid collection portion 107c in the form of a narrow trench, so that the liquid collected in the recess portion 104c may be effectively moved to the liquid collection portion 107c.

On the liquid collection surface 101c of the frame 10c, the hydrophobic layer 103 (described above in FIG. 5) may be formed, and repeated descriptions thereof will be omitted.

Additionally, the protrusions and depressions structure described above in FIG. 6 and FIG. 7 may be formed on the liquid collection surface 101c of the frame 10c, and repeated explanations thereof will be omitted.

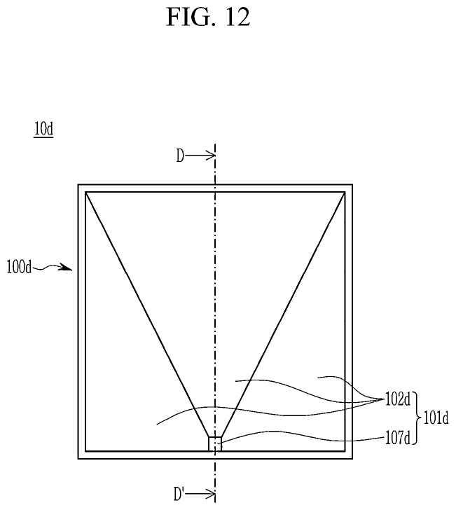

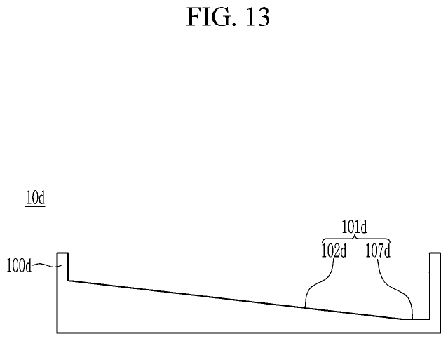

FIG. 12 is a top plan view of a frame 10d according to a third embodiment. FIG. 13 is a longitudinal cross-sectional view taken along a line D-D′ of FIG. 12.

Referring to FIG. 12 and FIG. 13, a frame 10d has a container structure of which an upper part is opened upward. The liquid collection surface 101d is positioned at the upper portion of the frame 10d. The liquid collection surface 101d is opened upward. The barrier 100d may be disposed on the outer circumference of the liquid collection surface 101d. The barrier 100d may protrude upward from the adjacent liquid collection surface 101d. The barrier 100d can be disposed to completely surround the outside of the liquid collection surface 101d.

The liquid collection surface 101d includes a slope portion 102d and a liquid collection portion 107d.

In the slope portion 102d, at least some regions are inclined with respect to the horizontal plane. The slope portion 102d may be inclined so that the height of the up-down direction is lower in the region farther from the outer edge of the liquid collection surface 101d than the region adjacent to the outer edge of the liquid collection surface 101d. As an example, the slope portion 102d may slope downward from the outer edge of the liquid collection surface 101d toward the direction away from the outer edge of the liquid collection surface 101d.

The liquid collection portion 107d is positioned on one side of the liquid collection surface 101d. The liquid collection portion 107d has the height lower than the region where the height of the up-down direction is the greatest by a predetermined value in the liquid collection surface 101d. The liquid collection portion 107d may have the lowest height of the up-down direction in the liquid collection surface 101d. The area of the liquid collection portion 107d may correspond to the size of the liquid leak sensor 20.

A distance from the outer edge of the liquid collection surface 101d to the liquid collection portion 107d may vary for each region along the circumference direction of the liquid collection portion 107d. In at least one or more straight line direction passing through the liquid collection portion 107d, the distance from the outer edge of the liquid collection surface 101d to the liquid collection portion 107d may be asymmetric in the regions facing each other with respect to the liquid collection portion 107d. As an example, one side of the liquid collection portion 107d may be positioned in contact with the barrier 100d.

The remaining structure of the frame 10d may have the same or similar structure as the frame 10 described above in FIG. 1 to FIG. 3, and repeated descriptions thereof will be omitted.

Also, the remaining structure of the frame 10d may have the same or similar structure as the frame 10b described above in FIG. 8 and FIG. 9, and repeated descriptions thereof will be omitted.

Also, the remaining structure of the frame 10d may have the same or similar structure as the frame 10c described above in FIG. 10 and FIG. 11, and repeated descriptions thereof will be omitted.

On the liquid collection surface 101d of the frame 10d, the hydrophobic layer 103 described above in FIG. 5 may be formed, and repeated descriptions thereof will be omitted.

Additionally, on the liquid collection surface 101d of the frame 10d, the protrusions and depressions structure described above in FIG. 6 and FIG. 7 may be formed, and repeated explanations for this will be omitted.

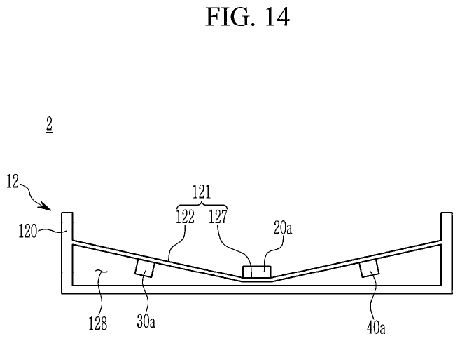

FIG. 14 is a longitudinal cross-sectional view of a liquid leak detection apparatus 2 according to another embodiment.

Referring to FIG. 14, a frame 12 has a container structure of which an upper portion is opened upward. The liquid collection surface 121 is positioned at the upper portion of the frame 12. The barrier 120 may be disposed on the outer circumference of the liquid collection surface 121. The barrier 12 may protrude upward from the adjacent liquid collection surface 121. The barrier 120 may completely surround the outside of the liquid collection surface 121.

The liquid collection surface 121 includes a slope portion 122 and a liquid collection portion 127.

In the frame 12, an empty area 128 is formed in the region below the liquid collection surface 121. As an example, the frame 12 may be a plate structure in which the region forming the liquid collection surface 121 has a predetermined thickness, so that the empty area 128 may be formed in a lower region of the liquid collection surface 121. The liquid leak sensor 20a is disposed on the liquid collection surface 121 of frame 12 and detects the liquid falling on the liquid collection surface 121 of the frame 12.

The vibration sensor 30a may be disposed inside the empty area 128. The vibration sensor 30a may be disposed on the inner upper surface of the empty area 128. Accordingly, the vibration sensor 30a may effectively detect the vibration generated on the liquid collection surface 121 as the liquid falls.

The vibration application member 40a may be disposed inside the empty area 128. The vibration application member 40a may be disposed on the inner upper surface of the empty area 128. Accordingly, the vibration generated from the vibration application member 40a may be effectively transmitted to the liquid collection surface 121.

The remaining structure of the frame 12 may have the same or similar structure as the frame 10 described above in FIG. 1 to FIG. 3, and repeated descriptions thereof will be omitted.

Additionally, the remaining structure of the frame 12 may have the same or similar structure as the frame 10b described above in FIG. 8 FIG. 9, and repeated descriptions thereof will be omitted.

Additionally, the remaining structure of the frame 12 may have the same or similar structure as the frame 10c described above in FIG. 10 FIG. 11, and repeated descriptions thereof will be omitted.

Additionally, the remaining structure of the frame 12 may have the same or similar structure as the frame 10d described above in FIG. 12 FIG. 13, and repeated descriptions thereof will be omitted.

On the liquid collection surface 121 of the frame 12, the hydrophobic layer 103 described above in FIG. 5 may be formed, and repeated descriptions thereof will be omitted.

On the liquid collection surface 121 of the frame 12, the protrusions and depressions structure described above in FIG. 6 and FIG. 7 may be formed, and repeated descriptions thereof will be omitted.

In addition, the configuration of which the description is omitted in the liquid leak detection apparatus 2 is the same or similar to the liquid leak detection apparatus 1 described above in FIG. 1 to FIG. 4.

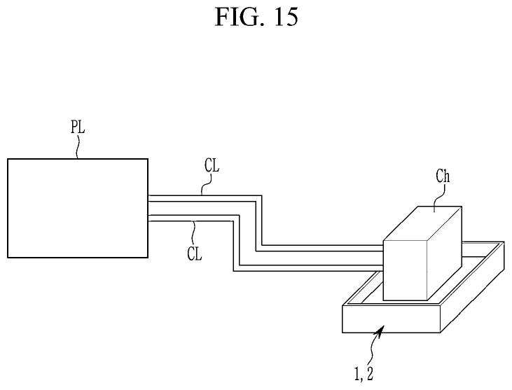

FIG. 15 to FIG. 18 are views showing a use state of a liquid leak detection apparatus 1 and 2 described above.

Hereinafter, the installation and use status of the above-mentioned liquid leak detection apparatus 1 and 2 will be described with reference to FIG. 15 to FIG. 18.

The liquid leak detection apparatus 1 and 2 may be installed in semiconductor production facilities and detect liquid leaks occurring in the semiconductor production facilities. The semiconductor production facilities may include a substrate processing facility PL. The substrate processing facility PL may performs a development process, a deposition process, an etching process, a cleaning process, a drying process, etc. on a substrate. Additionally, the substrate processing facility PL may be a group of devices that perform a development process, a deposition process, an etching process, a cleaning process, a drying process, etc. on the substrate, or a facility in which the group of these devices is positioned inside.

This substrate processing facility PL generates heat during the operation process, and a cooling is performed by circulating a refrigerant in the substrate processing facility PL. Accordingly, a cooling line CL for a refrigerant circulation is connected to the substrate processing facility PL. The cooling line CL is a piping structure that allows a refrigerant to flow inside. The refrigerant may be water or the like.

Additionally, the cooling line CL can be connected to a refrigerant circulation device Ch. The refrigerant circulation device Ch may provide a power for the refrigerant to flow through the cooling line CL. Additionally, the refrigerant circulation device Ch may cause (or generate) a phase change in the refrigerant, thereby allowing an effective heat transfer between the refrigerant and the substrate processing facility PL. As an example, the refrigerant circulation device Ch may be a chiller, etc.

The refrigerant may be leaked to the outside during the circulation process. The refrigerant that leaks out may become a liquid and fall downward. The semiconductor production facilities are equipped with high voltage wires, so the leakage of the refrigerant may cause a serious accident. Accordingly, if the leakage of the refrigerant occurs, it must be detected early and a maintenance work must be carried out to prevent the leakage of the refrigerant.

The refrigerant circulation device Ch includes a plurality of mechanical components, so there is a high possibility that the leakage of the refrigerant may occur due to an aging or a damage during a use process. Accordingly, as illustrated in FIG. 15, the liquid leak detection apparatus 1 and 2 may be installed underneath the refrigerant circulation device Ch. As an example, the refrigerant circulation device Ch may be installed on the liquid leak detection apparatus 1 and 2 through a fixing device such as a bracket.

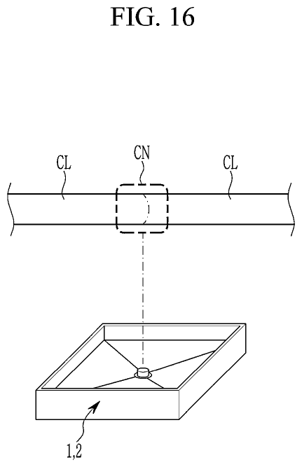

Additionally, the leakage of the refrigerant may occur in the cooling line CL due to an aging, an external impact, etc. Particularly, the leakage of the refrigerant is likely to occur in a connection region CN where unit sections of the cooling line CL are connected to each other. Accordingly, as shown in FIG. 16, the refrigerant circulation device Ch may be installed below the connection region CN where the unit sections are connected to each other in the cooling line CL.

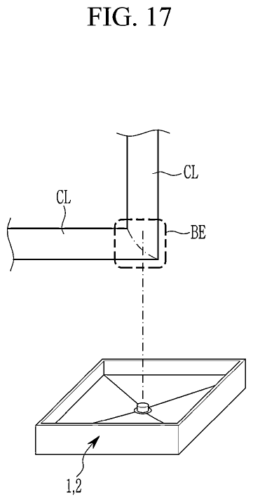

Additionally, if the cooling line CL has a slope, the refrigerant discharged from the cooling line CL may flow along the outer surface of the cooling line CL. After this, the refrigerant is likely to fall after condensing in a bending section BE of the cooling line CL. Accordingly, as illustrated in FIG. 17, the liquid leak detection apparatus 1 and 2 may be installed below the bending section BE in the cooling line CL.

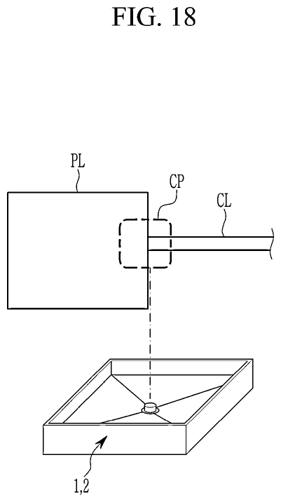

Additionally, a junction portion CP is positioned in the region where the cooling line CL and the substrate processing facility PL meet. In other words, the cooling line CL is installed as a separate configuration from the substrate processing facility PL in a mutual-combining type with each other. Accordingly, if a gap occurs in the junction portion CP due to an aging, an external impact, etc., the leakage of the refrigerant may occur. Accordingly, as shown in FIG. 18, the liquid leak detection apparatus 1 and 2 may be installed below the junction portion CP of the cooling line CL and the substrate processing facility PL.

While this disclosure has been described in connection with what is presently considered to be a practical exemplary embodiment, it is to be understood that the disclosure is not limited to the disclosed embodiment, but, on the contrary, is intended to cover various modifications and equivalent arrangements included within the spirit and scope of the appended claims.

What is claimed is:

1. A liquid leak detection apparatus comprising:
a frame having a container structure and comprising a liquid collection surface at an upper part of the frame; and
a liquid leak sensor on the liquid collection surface,
wherein the liquid collection surface comprises a liquid collection portion that is disposed on one side of the liquid collection surface,
wherein the liquid collection portion is lower in height by a predetermined value than a region where a height of an up-down direction is the greatest in the liquid collection surface, and
wherein the liquid leak sensor is on the liquid collection portion.

2. The liquid leak detection apparatus of claim 1, wherein the liquid collection surface further comprises a slope portion that slopes downward in a direction from a region distant from the liquid collection portion to the liquid collection portion.

3. The liquid leak detection apparatus of claim 2, wherein a hydrophobic layer is on the slope portion.

4. The liquid leak detection apparatus of claim 2, wherein the slope portion has a plurality of protrusions and a plurality of depressions.

5. The liquid leak detection apparatus of claim 2, wherein the liquid collection surface further comprises at least one guide panel protruding upward on the slope portion.

6. The liquid leak detection apparatus of claim 5, wherein one end of the at least one guide panel is adjacent to an outer edge of the liquid collection surface, and
wherein the other end of the at least one guide panel is adjacent to the liquid collection portion.

7. The liquid leak detection apparatus of claim 5, wherein the at least one guide panel corresponds to a plurality of guide panels, and
wherein the plurality of guide panels are arranged radially on a circumference of the liquid collection portion.

8. The liquid leak detection apparatus of claim 2, wherein the slope portion has different heights for each region along a first direction perpendicular to a second length direction toward the liquid collection portion from an outer edge of the liquid collection surface.

9. The liquid leak detection apparatus of claim 8, wherein the slope portion comprises:
a recess portion of which a height of an up-down direction is lower than a region adjacent in the first direction perpendicular to the second direction; and
a sliding portion respectively disposed on both sides of the recess portion in the first direction perpendicular to the second direction.

10. The liquid leak detection apparatus of claim 9, wherein the recess portion slopes so that the side toward the liquid collection portion faces downward along the second direction.

11. The liquid leak detection apparatus of claim 1, further comprising at least one controller configured to detect liquid on the liquid collection surface through a signal received from the liquid leak sensor.

12. The liquid leak detection apparatus of claim 11, further comprising a notification circuit configured to output a warning signal,
wherein the at least one controller is configured to detect the liquid and transmit the warning signal to the notification circuit.

13. The liquid leak detection apparatus of claim 1, further comprising a vibration sensor configured to detect vibration occurring in the frame.

14. The liquid leak detection apparatus of claim 13, wherein the frame has an empty area placed in a lower region of the liquid collection surface, and
wherein the vibration sensor is inside the empty area.

15. The liquid leak detection apparatus of claim 13, further comprising a vibration application member configured to generate vibration in the frame.

16. A liquid leak detection apparatus comprising:
a frame having a container structure and comprising a liquid collection surface positioned at an upper part of the frame; and
a liquid leak sensor on the liquid collection surface,
wherein the liquid collection surface comprises a liquid collection portion on one side of the liquid collection surface,
wherein the liquid collection portion is lower in height by a predetermined value than a region where a height of an up-down direction is the greatest in the liquid collection surface,
wherein the liquid collection portion has an area corresponding to a size of the liquid leak sensor,
wherein the liquid collection surface comprises a slope portion that slopes downward in a direction from a region farthest from the liquid collection portion toward to the liquid collection portion, and
wherein the liquid leak sensor is on the liquid collection portion.

17. The liquid leak detection apparatus of claim 16, wherein a hydrophobic layer is on the slope portion.

18. The liquid leak detection apparatus of claim 16, wherein the slope portion has a plurality of protrusions and a plurality of depressions.

19. The liquid leak detection apparatus of claim 16, wherein the liquid collection surface further comprises at least one guide panel protruded upward on the slope portion, and
wherein the at least one guide panel has one end adjacent to an outer edge of the liquid collection surface and the other end adjacent to the liquid collection portion.

20. A liquid leak detection apparatus comprising:
a frame having a container structure and comprising a liquid collection surface at an upper part of the frame; and
a liquid leak sensor on the liquid collection surface,
wherein the liquid collection surface comprises a liquid collection portion on one side of the liquid collection surface,
wherein the liquid collection portion is lower in height by a predetermined value than a region where a height of an up-down direction is the greatest in the liquid collection surface,
wherein the liquid collection portion has an area corresponding to a size of the liquid leak sensor,
wherein the liquid collection surface comprises a slope portion that slopes downward in a direction from a region farthest from the liquid collection portion to the liquid collection portion,
wherein the liquid collection surface comprises a plurality of guide panels protruded upward on the slope portion and arranged radially on a circumference of the liquid collection portion, and
wherein the liquid leak sensor is disposed on the liquid collection portion.
